(19) United States
(12) Patent Application Publication
(10) Pub. No.: US 2009/0186544 A1
(43) Pub. Date: Jul. 23, 2009

(54) FORMING FABRIC FOR A MACHINE FOR THE PRODUCTION OF WEB MATERIAL AND METHOD TO PRODUCE SAID FORMING FABRIC

(76) Inventors: Arved Westerkamp, Dettingen (DE); Hubert Walkenhaus, Kerpen (DE); Robert Crook, Wilson, NC (US)

Correspondence Address: TAYLOR & AUST, P.C., P.O. Box 560, 142. S Main Street, Avilla, IN, 46710, US

(21) Appl. No.: 12/339,449

(22) Filed: Dec. 19, 2008

Related U.S. Application Data
(60) Provisional application No. 61/015,863, filed on Dec. 21, 2007.

(51) Int. Cl. B32B 27/02; B32B 7/12

(52) U.S. Cl. 442/164; 156/327

(57) ABSTRACT

A belt for a machine for the production of web material, especially paper or cardboard, including a carrying structure and, on one web material contact side of the carrying structure, a fibrous material with polymeric material contained therein. A bulk of the polymeric material is provided in a volumetric area of the fibrous material which is close to a web material contact surface.

### CROSS REFERENCE TO RELATED APPLICATIONS

This is a non-provisional application based upon U.S. provisional patent application Ser. No. 61/015,863, entitled “DIFFERENTIAL PRESSING STRUCTURE”, filed Dec. 21, 2007, which is incorporated herein by reference.

### BACKGROUND OF THE INVENTION

1. Field of the Invention

The present invention relates to a belt for a machine for the production of web material, especially paper or cardboard, as well as a method to produce the belt.

2. Description of the Related Art

Belts are utilized, for example, in dryer sections of paper machines which transport the web material to be produced through press nips created, for example, by two press rolls. Due to the physical load, the web material which is to be produced is compressed and liquid is squeezed from it. The liquid is to be absorbed by, and removed through, the belt which is in contact with the web material. A method is already known whereby the surface of a belt of this type is covered with thin material layers which, in order to permit liquid strike-through, are equipped with a plurality of openings. The production of such belt is very expensive and often results in insufficient water removal characteristic, as well as a tendency of marking.

What is needed in the art is a belt for a machine for the production of web material, especially paper or cardboard, as well as a method for the production of a belt of this type with which marking of the web material which is to be produced can be largely eliminated if the belt has good liquid removal characteristics.

### SUMMARY OF THE INVENTION

The present invention provides a belt, especially a press felt, for a machine for the production of web material, for example, paper or cardboard including a carrying structure having a web material contact side. The carrying structure includes fibrous material with polymeric material contained therein which, together with the fibers of the fibrous material, create a fluid-permeable composite structure in that the polymeric material only partially fills and/or bridges the hollow spaces between fibers of the fibrous material and, whereby, a large part of the polymeric material is provided in a volumetric area of the fibrous material which is close to a web material contact surface. “Close,” as used in the specification and claims herein, is defined as a depth range of approximately 30% in the fibrous material viewed from the web material contact surface.

In other words, a permeable composite structure is created in the area of the web material contact surface by the fibers of the fibrous material and the polymeric material. The fibers are embedded, at least partially, into the polymeric material. The porosity of the composite structure is created in that the polymeric material only partially fills and/or bridges the hollow spaces between the fibers of the fibrous material. This means that the polymeric material itself is not porous or for example, foamed.

Since, in the belt of the present invention, the polymeric material contained in the fibrous material is provided in an area near the surface, or essentially also in an area of the fibrous material representing a web material contact surface, a predominantly mat-type configuration is formed by this polymeric material which nevertheless allows liquid to penetrate. Since this polymeric material is embedded into the structure of the fibrous material, the structure of the fibrous material will mark the web material contact surface in the style of a micro-structuring. On the one hand, this is not so strong as to mark the web material which is being manufactured but, on the other hand, permits better release of a belt of this type from the web material which is being manufactured due to the existing irregularity and in conjunction with the porosity.

Provision may be made, for example, that at least 80% of the polymeric material is provided at a depth range of approximately 20% in the fibrous material viewed from the web material contact surface. The belt of the present invention may include a plurality of layers of fibrous material, whereby, the bulk of the polymeric material is provided in the layer of fibrous material representing the web material contact surface.

In order to be able to even more efficiently provide the desired hollow space structure in conjunction with the polymeric material and, consequently, also the desired liquid absorption characteristic, the layer of fibrous material which represents the web material contact surface is finer than the layer of fibrous material beneath it. It may, for example, be provided that the layer of fibrous material representing the web material contact surface may be composed of fibers with a maximum of 17 dtex. In this context it is pointed out that, with regard to the present invention, “finer” is to be understood to mean that fewer hollow spaces are present in a layer of this type than in a coarser layer. This can be achieved, for example, by utilizing fibers of comparatively lower dtex value and, on the other hand, can also be influenced by the density of such a layer.

The polymeric material may form a single-component and permeable polymeric layer. In other words, a single-component and permeable polymeric layer is formed, which extends through the fibrous material in the area of the web material contact surface and, which is embedded, at least partially, in the fibers of the fibrous material. The polymeric layer is solidly bonded with the fibers.

A single-component polymeric layer is understood to be a polymeric layer which is formed by a single continuous piece. In order to provide permeability, the polymeric layer includes openings extending through the polymeric layer, and the openings in the polymeric layer are formed in that the polymeric material, which forms the polymeric layer, only partially fills and/or bridges the hollow spaces between the fibers of the fibrous layer. To verify that the permeable polymeric layer is a single component, the fibrous material—if it is, for example, polyamide—can be dissolved, for example, with formic acid.

With fibers of the fibrous material, the single component and permeably polymeric layer forms a permeable composite structure which provides a high water drainage capacity and does not compress much during operation. Due to the fact that the polymeric material forms a single component polymeric layer, the polymeric material separates from the fibrous material less easily when under the influence of shear forces or high pressure water jets than is the case with polymeric material which only forms a multitude of disconnected polymeric agglomerates in the fibrous material.

The present invention also provides a method for the manufacture a belt for a machine for the production of web material, including the following measures:
a) Provision of a carrying structure;
b) Provision of fibrous material at a web material contact side of the carrying structure; and
c) Provision of polymeric material, essentially only in a volume range of the fibrous material close to a web material contact surface, whereby the polymeric material, together with the fibers of the fibrous material, forms a permeable composite structure in that the polymeric material only partially fills and/or bridges the hollow spaces between the fibers of the fibrous material.

In order to simply achieve the desired layering, it is further suggested that measure b) include the provision of several layers of fibrous material on the carrying structure and that measure c) include the provision of the polymeric material essentially in only one layer of fibrous material providing a web material contact surface.

The layer of fibrous material providing the web material contact surface may be finer than a layer of fibrous material located beneath it. This results in the liquid, penetrating through the layer representing the web material contact surface and containing the polymeric material, can move very quickly through the coarser structure of the layer located beneath it, so that the risk of back-moistening can be clearly reduced.

Measure c) may include adding an aqueous dispersion with particle-like polymeric material from a web material contact side and melting the particle-like polymeric material. Prior to the melting process, liquid, which was added with the dispersion, can be removed from the fibrous material or carrying structure.

The carrying structure may, for example, be woven or randomly laid. The fibrous material may be non-woven or felt.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a schematic sectional drawing of an inventively composed belt;

FIG. 2 illustrates a schematic top view onto a web material contact surface of the belt in FIG. 1;

FIG. 3 illustrates a electron-microscopical micrographic of a web material contact surface of the belt of the present invention;

FIG. 4 illustrates an additional electron-microscopical micrographie of a web material contact surface with a different surface structure.

Corresponding reference characters indicate corresponding parts throughout the several views. The exemplifications set out herein illustrates one embodiment of the invention, in one form, and such exemplifications are not to be construed as limiting the scope of the invention in any manner.

### DETAILED DESCRIPTION OF THE INVENTION

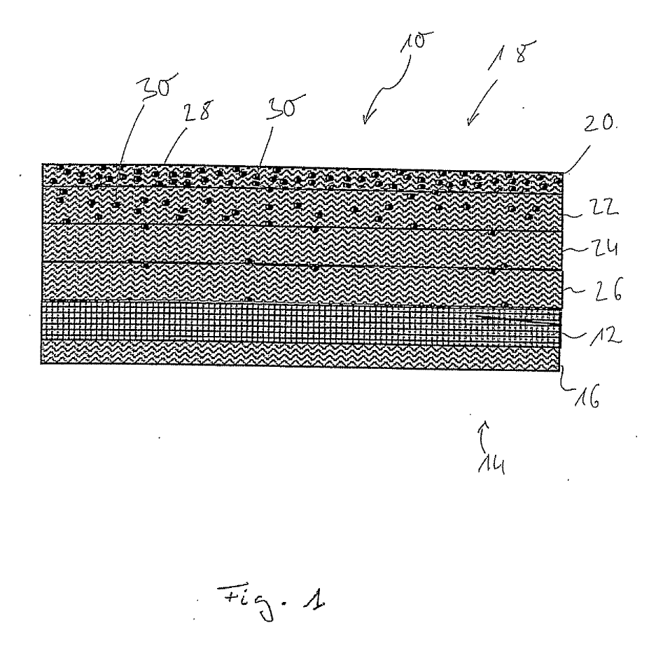

Referring now to the drawings and more particularly to FIG. 1, there is shown a schematic sectional drawing of belt 10. This belt, which may, for example, be in the embodiment of endless belt 10, utilized in a dryer section of a paper machine. Belt 10 includes carrying structure 12 which absorbs the mechanical load, especially in a longitudinal and cross direction of the fabric. Carrying structure 12 may, for example, be in the embodiment of a woven fabric, a randomly laid structure or a spiral-link structure. Layer 16 of fibrous material, for example, a felt layer or a non-woven layer, may be provided on machine contact side 14 of carrying structure 12, which may be bonded with carrying structure 12, for example, through needling. A total of four layers 20, 22, 24, 26 of fibrous material are provided on web material contact side 18 in the illustrated design example which, again, may be non-woven or felt. Also layers 20, 22, 24, 26 may be firmly bonded with carrying structure 12 by means of needling.

It can be seen that especially in layer 20 of fibrous material, which represents web material contact surface 28, a multitude of particles 30 of polymeric material are provided. Also, particles 30 of this type may still be present in layer 22 of fibrous material located immediately beneath it, and in additional layers 24, 26 of fibrous material, whereby however a bulk, for example, at least half, of particles 30 are contained in uppermost layer 20 of fibrous material representing the web material contact surface. A “bulk” of the polymeric material as used in the specifications and claims herein is defined as at least half of the particles, for example, 80% of the polymeric material.

FIG. 1 illustrates belt 10 in an intermediate production phase, that is, after secure bonding, various layers 20, 22, 24, 26, and possibly 16 of fibrous material with carrying structure 12, for example, by means of needling, and also after adding particles 30 of polymeric material. Adding particles 30 can occur, for example, after bonding layers 20, 22, 24, 26 of fibrous material with carrying structure 12, an aqueous dispersion, containing particles 30 is applied onto web material contact surface 28. With this aqueous dispersion particles 30 are also furnished into the interior volume area, resulting in the dispersion that is illustrated in FIG. 1. In order to ensure that the majority of particles 30 remain in the area near the surface, in other words primarily in layer 20 of fibrous material, layer 20 is created with an accordingly fine structure so that, especially when coordinating the size, or the average size, of particles 30, these remain primarily in layer 20 of fibrous material. Consequently, layer 20 of fibrous material is provided, for example, consisting of fibers having a comparatively low dtex-number, for example, below 20 dtex, and also a comparatively high density, that is a high fiber content per volume unit, so that the pores remaining in layer 20 of fibrous material, are so small that a bulk of particles 30 becomes entangled in them. The fibers of layer 20 of fibrous material may have a dtex value in the range of 6 to 17, while, for example, layer 22 of fibrous material which is located immediately beneath it, may be composed of fibers having a dtex value of approximately 44. The size distribution of particles 30 may be such that at least 50% of them are of the same size, in the range of 20 to 220 μm. Some of the smaller particles may, of course, also get into next layer 22 of fibrous material and may get entangled in pores there. The density of particles 30, however, greatly reduces in the direction of web material contact surface 28, so that such particles are present to a relevant degree essentially only within the first 30% of depth, measured from web material contact surface 28. At least 80% of particles 28 may be present within the first 20% of depth. If layers 22, 24, 26, which are located beneath first layer 20 of fibrous material, have a clearly coarser structure, in other words, a larger pore volume, provision may, for example, be made that particles 30 emerging from layer 20 will not become entangled in these layers, or on carrying structure 12 either, so that they are again removed from belt 10 together with the liquid which is removed, for example, by means of vacuum, a blower or drying.

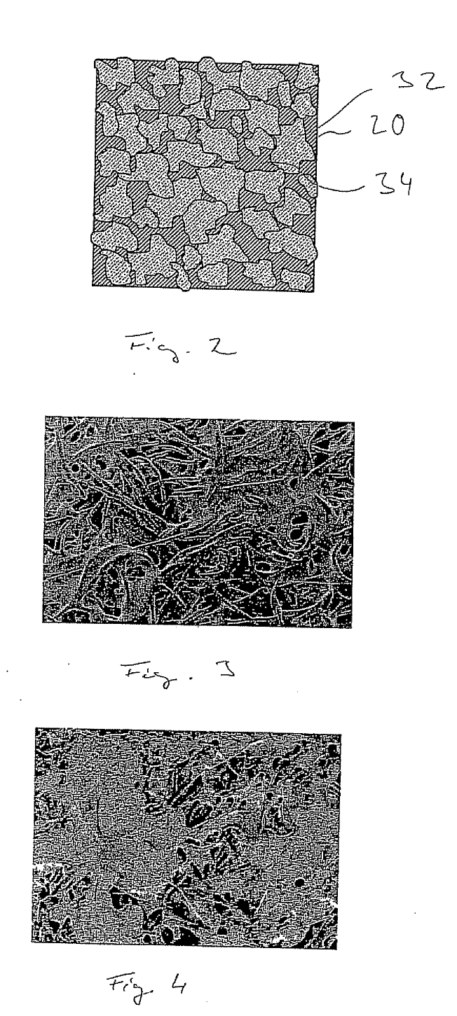

After adding particles 30, belt 10 is heated to a temperature above the melting temperature of the polymeric material of particles 30, for example, by means of running it through two heated rolls. Heating in an appropriate heating chamber is also feasible. For this purpose the belt can be heated, for example, for two minutes to a temperature of approximately 200° C. The melting point of thermoplastic polyurethane material which may, for example, be used for particles 30, is around approximately 187° C., while the melting point for polyamide 6 fibers used for the fibrous material is around 223° C. This means that particle material 28 will melt, however, the fibers of the fibrous material will retain their structure. The melting polymeric material will then distribute itself in the porous structure of the layer of fibrous material containing same, so that—as shown in FIG. 2—polymeric material 32 will form in this respective layer which, together with fibers of the layer, will form a permeable composite structure in that the polymeric material only partially fills and/or bridges (see FIGS. 3 and 4) the hollow spaces between the fibers of the layer. The volume areas of polymeric material 33, which are created by the melting particles, are connected with each other and form a structure with a plurality of pores 34 between them. The polymeric material will also envelope the fibers and interconnect them at their crossing points, so that the permeable composite structure of polymeric material and the fibrous material which is embedded in the polymeric material that is illustrated in FIGS. 3 and 4 is obtained. The web material surface of this mat-type composite of polymeric material, also illustrated in FIGS. 3 and 4, displays a micro-structuring created by the raised areas provided by the fibers on the polymeric material. This structuring is too small to mark the web material which is being produced with a forming fabric of this type. It does, however, facilitate the release of the belt from the web material due to the fact that the composite structure representing the web material contact surface possesses a very large number of open pores.

In an embodiment, the polymeric material forms a single component and permeable polymeric layer in the area of the web material contact surface. It is self evident that the principles of the invention may also be realized with other embodiments. For example, the number of layers of fibrous material may vary from the cited number of layers. Also, with only one, for example, thicker layer of fibrous material and, by adaptation of the particle size on the one hand and the fineness of the layer on the other hand, it can be provided that a bulk of the particles accumulates in the area near the surface so that the mat-type configuration with essentially high porosity is achieved during melting and subsequent curing.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A belt for a machine for the production of a fibrous web material, the belt comprising:
a carrying structure having a web material contact side, said carrying structure including a fibrous material having a plurality of fibers and a polymeric material, said fibers and said polymeric material being configured to form a fluid-permeable composite structure having hollow spaces between said fibers, said hollow spaces being at least one of only partially filled with said polymeric material and bridged by said polymeric material, wherein a bulk of said polymeric material is provided in a volumetric area of said fibrous material being substantially close to said web material contact surface.

2. The belt of claim 1, wherein at least 80% of said polymeric material is provided at a depth range of approximately 20% in said fibrous material when viewed from said web material contact side.

3. The belt of claim 2, said fibrous material further comprising a plurality of layers of fibrous material including a first layer having a web material contact surface, said first layer including a bulk of said polymeric material.

4. The belt of claim 3, wherein said plurality of layers of fibrous material includes a second layer being positioned directly beneath said first layer having a web material contact surface, said first layer being finer than said second layer.

5. The of claim 4, wherein said fibers of said first layer having said web material contact surface have a maximum of approximately 17 dtex.

6. The belt of claim 5, wherein said polymeric material is configured to form a single-component and permeable polymeric layer.

7. A method for manufacturing a belt for a machine for the production of web material, the method comprising:
(a) providing a carrying structure having a web material contact side;
(b) providing a fibrous material on said web material contact side of said carrying structure, said fibrous material having a web material contact surface and including a plurality of fibers; and
(c) providing polymeric material only in a volume range of said fibrous material being substantially close to said web material contact surface, said polymeric material and said plurality of fibers being configured to form a permeable composite structure having hollow spaces between said fibers, said hollow spaces being at least one of partially filled with said polymeric material and bridged by said polymeric material.

8. The method for manufacturing the belt according to claim 7, said step (b) further comprising the step of providing a plurality of layers of fibrous material on said carrying structure.

9. The method for manufacturing the belt according to claim 8, said step (c) further comprising the step of providing said polymeric material substantially in only one layer of said fibrous material having a web material contact surface.

10. The method for manufacturing the belt according to claim 8, wherein said plurality of layers of fibrous material includes a first layer having a web material contact surface and at least a second layer directly beneath said first layer, said first layer being finer than said second layer.

11. The method for manufacturing the belt according to claim 8, wherein said step (c) further comprising the step of adding an aqueous dispersion with particle-like polymeric material from said web material contact side and melting said particle-like polymeric material.

12. The method for manufacturing the belt according to claim 10, wherein prior to melting said particle-like polymeric material, liquid is removed from said fibrous material and said carrying structure.

13. The method for manufacturing the belt according to claim 11, wherein said carrying structure is one of a woven and a randomly laid structure.

14. The method for manufacturing the belt according to claim 12, wherein said fibrous material is one of non-woven and felt.
